(19) United States
(12) Patent Application Publication
(10) Pub. No.: US 2025/0370874 A1
(43) Pub. Date: Dec. 4, 2025

(54) HYBRID PARITY FOR THREE-DIMENSIONAL MEMORY

(71) Applicant: Micron Technology, Inc., Boise, ID (US)

(72) Inventor: Makoto Kitagawa, Folsom, CA (US)

(21) Appl. No.: 19/213,778

(22) Filed: May 20, 2025

Related U.S. Application Data
(60) Provisional application No. 63/653,029, filed on May 29, 2024.

(51) Int. Cl. G06F 11/10

(52) U.S. Cl. CPC G06F 11/1096

(57) ABSTRACT

Various examples are directed to systems and methods involving a memory device comprising a memory array comprising a number of memory cells arranged into a number of pages, a number of rows, and a number of columns. Each respective memory cell of the number of memory cells may be part of a column of the number of columns, a row of the number of rows, and a page of the number of pages. A first column of the number of columns may be electrically coupled to store parity data for a first portion of the number of pages and column redundancy data for a second portion of the number of pages.

### PRIORITY APPLICATION

This application claims the benefit of priority to U.S. Provisional Application Ser. No. 63/653,029, filed May 29, 2024, which is incorporated herein by reference in its entirety.

### BACKGROUND

Memory devices are typically provided as internal, semiconductor, integrated circuits (ICs) in computers or other electronic devices. There are many different types of memory, including volatile and non-volatile memory. Volatile memory requires power to maintain its data, and includes random-access memory (RAM), dynamic random-access memory (DRAM), static RAM (SRAM), or synchronous dynamic random-access memory (SDRAM), among others. Non-volatile memory can retain stored data when not powered and includes flash memory, read-only memory (ROM), electrically erasable programmable ROM (EEPROM), erasable programmable ROM (EPROM), resistance-variable memory, such as phase-change random-access memory (PCRAM), resistive random-access memory (RRAM), magnetoresistive random-access memory (MRAM), or three-dimensional (3D) XPoint™ memory, among others. Properties of memory devices and other electronic devices can be improved by enhancements to the design and fabrication of components of the electronic devices such as, but not limited to, memory devices in an IC for the electronic devices.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an example of an environment including a memory device.

FIG. 2 is a schematic of an electrical arrangement of components of an embodiment of an example DRAM device.

FIG. 3 is a diagram showing one example of a memory device with a control circuit and a memory array including a hybrid column.

FIG. 4 is a diagram showing one example of a memory device including a hybrid column.

FIG. 5 is a flowchart showing one example of a process flow that may be implemented in a memory device utilizing at least one hybrid column to respond to a read request.

FIG. 6 is a flowchart showing one example of a process flow that may be implemented in a memory device utilizing at least one hybrid column to respond to a write request.

FIG. 7 is a block diagram illustrating an example of a machine upon which one or more embodiments may be implemented.

### DETAILED DESCRIPTION

Various examples described herein are directed to memory devices with memory arrays arranged in a three-dimensional manner, referred to herein as 3D memory arrays. A 3D memory array may be arranged in a three-dimensional manner logically or physically, such as, for example, a 3D DRAM device. A memory array that is arranged in a three-dimensional manner may comprise memory cells that are addressable for reading and writing in three dimensions. Consider an example memory array in which a first dimension is indicated by columns of memory cells, a second dimension is indicated by rows of memory cells and a third dimension is indicated by pages of memory cells. In this example, each memory cell may be identified by a unique combination of column, row, and page.

In some examples, 3D memory arrays may experience non-random error rates in one or more dimensions. Consider an example 3D DRAM device having memory cells that are arranged physically in three dimensions. Memory cells may be arranged into columns and rows parallel to a die substrate. Various tiers of rows and columns may be built up from the die substrate, where each tier may constitute a page of memory cells.

In some 3D DRAM devices, error rates are higher for memory cells that are positioned further from a plane of the die (e.g., pages corresponding to higher-positioned tiers of memory cells). For example, 3D DRAM memory cells fabricated farther from the plane of the die may tend to experience higher bit error rates (BER) and higher code word error rates (CWER).

In some examples, a memory device can include an error correction circuit. When data is written to the memory device, the error correction circuit may generate one or more parity bits describing the data to be written. Both the data to be written and the parity bits are written to memory cells at the memory device.

The memory device can receive a read command indicating a portion of the memory cells to be read. Read data and its corresponding parity bits are sensed from the indicated memory cells. The error correction circuit uses the parity bits to detect bit errors that may have occurred in the read data and, in some examples, to correct detected bit errors.

The extent of bit errors that are detectable and correctable may depend on the number of parity bits used. For example, using some example error correction code (ECC) algorithms, storing 1 parity bit per 8-bit word may allow the error correction circuit to detect up to 2 bit errors per 8-bit word and correct a single bit error. Similarly, using 2 parity bits per 8-bit word may allow the error correction circuit to detect 3 bit errors per 8-bit word and correct as many as 2 bit errors per 8-bit word. Accordingly, using additional parity bits may allow the detection and correction of more significant bit errors at the memory cells, but at the expense of reduced storage efficiency resulting from the storage of the additional parity bits.

In some memory devices, error rates may not be randomly distributed across one or more dimensions of the memory array. For example, some 3D DRAM devices experience bit errors more frequently in pages or tiers of memory cells that are spaced physically farther away from a plane of a die than in pages or tiers of memory cells that are physically closer to the plane of the die may experience fewer bit errors.

It may be challenging to select an appropriate number of parity bits for memory arrays having nonrandom distributions of error rates. For example, using an appropriate number of parity bits for memory cells in positions (e.g., pages) having higher error rates may result in reduced storage efficiency with respect to memory cells in positions (e.g., pages) having lower error rates that may otherwise operate effectively with fewer parity bits. Similarly, selecting an appropriate number of parity bits for memory cells in positions (e.g. pages) having lower error rates may result in an increased number of undetected and/or uncorrected bit errors for memory cells in positions (e.g., pages) having higher error rates.

Various examples address these and other challenges using memory arrays that include hybrid columns of memory cells. Consider an example in which memory cells are arranged in a three-dimensional manner into rows, columns, and pages, and for which errors increase with increasing page number. A selected number of columns may be used to store parity data with respect to other columns in the same page. A hybrid column may store parity data for a first set of pages and other data for a second set of the pages. The first set of pages may use an (additional) parity bit, increasing the robustness of error detection and correction. At the same time, the memory cells of the hybrid column that are not needed to store one or more parity bits for the second set of pages may be used for other storage purposes such as, for example, to provide additional column redundancy as described herein. In some examples, the first set of pages may be pages that are more likely to experience errors such as, for example, pages of some 3D DRAM devices that are farther from the plane of the die.

In some examples, memory cells of a hybrid column corresponding to the second set of pages may be used as column redundancy memory cells. For example, column redundancy columns of memory cells may be memory cells created in a memory array during fabrication. If one or more columns of memory cells in the memory array are found to be defective, for example, during or after fabrication, the memory device may be rewired such that read and write request that would otherwise have been directed to and/or from the defective column or columns are, instead, directed to memory cells in the column redundancy column. In this way, overall yield may be increased as the fabrication process may be tolerant to the failure of a limited number of columns. Accordingly, using the memory cells of a hybrid column corresponding to less-error-prone memory cells for column redundancy may increase the overall fabrication yield.

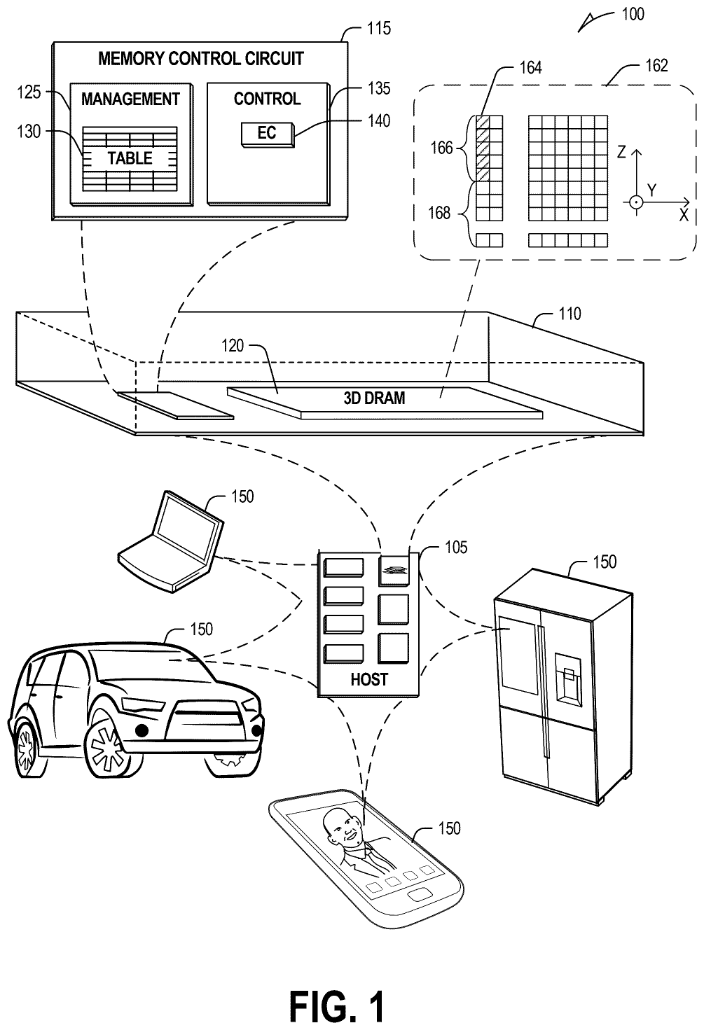

FIG. 1 illustrates an example of an environment 100 including a host device 105 and a memory device 110 configured to communicate over a communication interface. An electronic device comprising the host device 105 and/or the memory device 110 may be included in a variety of products 150, such as Internet of Things (IoT) devices (e.g., a refrigerator or other appliance, sensor, motor or actuator, mobile communication device, automobile, drone, and/or the like), computers (e.g., laptop computers, desktop computers, and/or the like) to support processing, communications, or control of the product 150.

The memory device 110 includes a memory control circuit 115 and a memory array 120 including, for example, one or more individual memory dies (e.g., one or more 3D DRAM arrays). In 3D architecture semiconductor memory technology, vertical structures are stacked, increasing the number of tiers, physical pages, and accordingly, the density of a memory device (e.g., a storage device). In an example, the memory device 110 can be a discrete memory or storage device component of the host device 105. In other examples, the memory device 110 can be a portion of an integrated circuit (e.g., system on a chip (SOC), etc.), stacked or otherwise included with one or more other components of the host device 105.

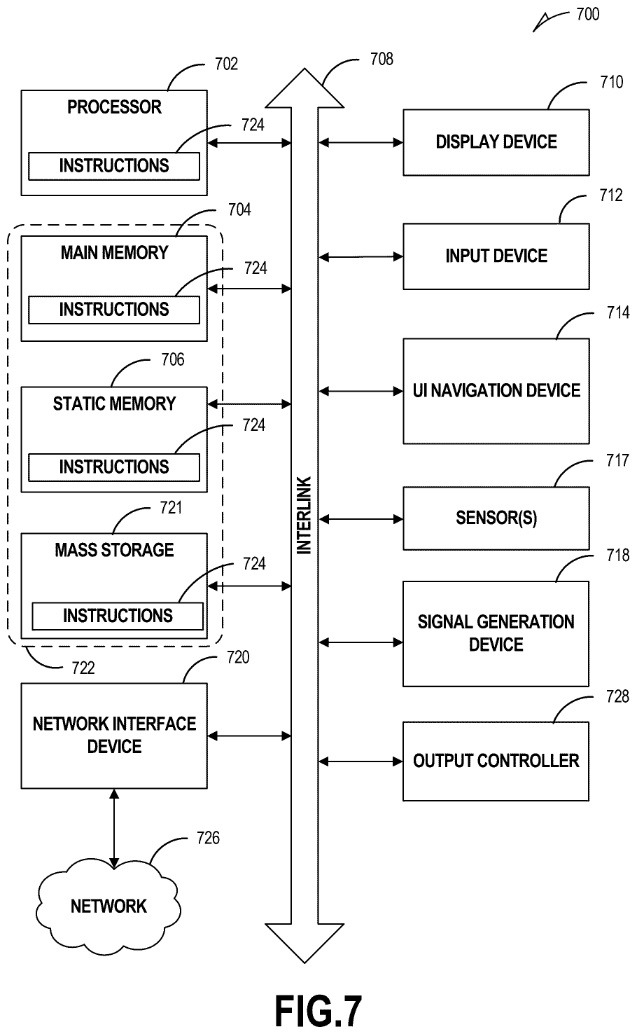

One or more communication interfaces can be used to transfer data between the memory device 110 and one or more other components of the host device 105, such as a Serial Advanced Technology Attachment (SATA) interface, a Peripheral Component Interconnect Express (PCIe) interface, a Universal Serial Bus (USB) interface, a Universal Flash Storage (UFS) interface, an eMMC™ interface, or one or more other connectors or interfaces. The host device 105 can include a host system, an electronic device, a processor, a memory card reader, or one or more other electronic devices external to the memory device 110. In some examples, the host device 105 may be a machine having some portion, or all, of the components discussed in reference to the machine 700 of FIG. 7.

Electronic devices, such as mobile electronic devices (e.g., smart phones, tablets, etc.), electronic devices for use in automotive applications (e.g., automotive sensors, control units, driver-assistance systems, passenger safety or comfort systems, etc.), and internet-connected appliances or devices (e.g., IoT devices, etc.), have varying storage needs depending on, among other things, the type of electronic device, use environment, performance expectations, etc.

Electronic devices can be broken down into several main components: a processor (e.g., a central processing unit (CPU) or other main processor); memory (e.g., one or more volatile or non-volatile RAM memory device, such as DRAM, mobile or low-power double-data-rate synchronous DRAM (DDR SDRAM), etc.); and a storage device (e.g., non-volatile memory (NVM) device, such as flash memory, ROM, an SSD, an MMC, or other memory card structure or assembly, etc.). In certain examples, electronic devices can include a user interface (e.g., a display, touch-screen, keyboard, one or more buttons, etc.), a graphics processing unit (GPU), a power management circuit, a baseband processor, or one or more transceiver circuits, etc.

The memory control circuit 115 can receive instructions from the host device 105, and can communicate with the memory array, such as to transfer data to (e.g., write or erase) or from (e.g., read) one or more of the memory cells, planes, sub-blocks, blocks, or pages of the memory array. The memory control circuit 115 can include, among other things, circuitry or firmware, including one or more components or integrated circuits. For example, the memory control circuit 115 can include one or more memory control units, circuits, or components configured to control access across the memory array 120 and to provide a translation layer between the host device 105 and the memory device 110. The memory control circuit 115 can include one or more input/output (I/O) circuits, lines, or interfaces to transfer data to or from the memory array 120. The memory control circuit 115 can include a memory manager 125 and an array controller 135.

The memory manager 125 can include, among other things, circuitry or firmware, such as a number of components or integrated circuits associated with various memory management functions. For purposes of the present description example memory operation and management functions will be described in the context of DRAM memory. Persons skilled in the art will recognize that other forms of non-volatile memory may have analogous memory operations or management functions. Such DRAM management functions include memory cell refresh, error detection or correction, or one or more other memory management functions. The memory manager 125 can parse or format host commands (e.g., commands received from a host) into device commands (e.g., commands associated with operation of a memory array, etc.), or generate device commands (e.g., to accomplish various memory management functions) for the array controller 135 or one or more other components of the memory device 110.

The memory manager 125 can include a set of management tables 130 configured to maintain various information associated with one or more component of the memory device 110 (e.g., various information associated with a memory array or one or more memory cells coupled to the memory control circuit 115). For example, the management tables 130 can include information regarding one or more error counts (e.g., a write operation error count, a read bit error count, a read operation error count, an erase error count, etc.) for one or more portions of the memory cells coupled to the memory control circuit 115.

The array controller 135 can include, among other things, circuitry or components configured to control memory operations associated with writing data to, reading data from, or erasing one or more memory cells of the memory device 110 coupled to the memory control circuit 115. The memory operations can be based on, for example, host commands received from the host device 105, or internally generated by the memory manager 125 (e.g., in association with refreshing, error detection or correction, etc.).

The array controller 135 can include an error correction circuit 140. In some examples, the error correction circuit 140 is arranged to implement error correction code (ECC) or another suitable error correction algorithm. For example, when data is to be written to a page or other subunit of memory cells of the memory array 120, the error correction circuit 140 may generate one or more parity bits based on the data. The parity bits are written to one or more memory cells at the array, for example, in association with the data. When data is read from the memory array, the data and its associated parity bit or bits are provided to the error correction circuit 140. The error correction circuit may use the parity bits to, if possible, detect and correct any bit errors that may have occurred. In some examples, the error correction circuit 140 may be implemented in software that is executed by a processor, a microcontroller, or other suitable hardware at the memory control circuit 115.

The memory array 120 can include memory cells arranged in, for example, a number of devices, planes, sub-blocks, blocks, or pages. In some examples, the memory array 120 may be arranged in three dimensions physically and/or logically. For example, memory cells in the memory array 120 may be arranged in two rows, columns, and pages, as described herein. In some examples, data is written to or read from the memory array 120 in pages. Each page may comprise a memory cell corresponding to each combination of rows and columns, as described herein. In some examples, one or more memory operations (e.g., read, write, erase, etc.) can be performed on larger or smaller groups of memory cells, as desired.

A page of data can include a number of bytes of user data (e.g., a data payload including a number of sectors of data) and its corresponding metadata. A size of the page can refers to the number of bytes used to store the user data. As an example, a page of data can have a page size of 128 bits of user data (e.g., 8 columns of 8 bits) as well as a number of bytes (e.g., 32 B, 54 B, 224 B, etc.) of metadata corresponding to the user data, such as integrity data (e.g., error detecting or correcting code data), address data (e.g., logical address data, etc.), or other metadata associated with the user data.

Different types of memory cells or memory arrays can provide for different page sizes, or may use different amounts of metadata associated therewith. For example, different memory device types may have different bit error rates, which can lead to different amounts of metadata to ensure integrity of the page of data (e.g., a memory device with a higher bit error rate may use more bytes of parity data than a memory device with a lower bit error rate).

The memory control circuit 115 and memory array 120 can be configured to include one or more hybrid columns. For example, a breakout window 162 shows a cross-section of example memory cells from the memory array 120. The memory cells are indicated as boxes. In this example, columns of memory cells are in the direction indicated by the X-axis, rows of memory cells are in the direction indicated by the Y-axis and pages of memory cells are in the direction indicated by the Z-axis. An example hybrid column 164 is shown. For a first portion of the pages indicated by 166, memory cells of the hybrid column 164 are used to store parity data, for example, for data stored at memory cells in other columns that are part of the same page (e.g., columns and rows of the same page). For a second portion of the pages indicated by 168, memory cells of the hybrid column 164 are used for another purpose such as, for example, for column redundancy as described herein.

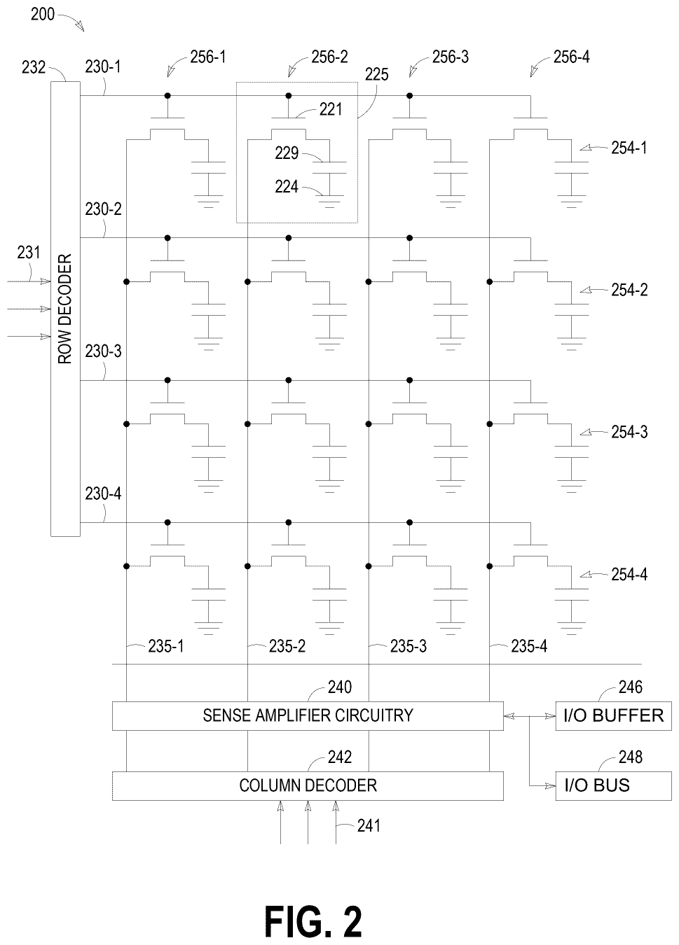

FIG. 2 is a schematic of an electrical arrangement of components of an embodiment of an example DRAM device 200. In an example, each of the memory cells includes a GAA transistor coupled to a capacitor. In some examples, the arrangement of FIG. 2 illustrates a page of memory cells as depicted and described in FIGS. 1 and 3-5. The memory cells can be coupled to bit lines (BLs), where each of the BLs may be wrapped on a sidewall of an active area of the GAA transistor of each memory cell to which the BL is coupled. Each word line (WL) can be structured contacting gates of GAA transistors of memory cells to which the given WL is coupled. The DRAM device 200 can include an array of memory cells 225 (only one being labeled in FIG. 2 for ease of presentation) arranged in rows 254-1, 254-2, 254-3, and 254-4 and columns 256-1, 256-2, 256-3, and 256-4. The physical orientation of the rows and columns is not shown. Further, while only four rows 254-1, 254-2, 254-3, and 254-4 and four columns 256-1, 256-2, 256-3, and 256-4 of four memory cells are illustrated, DRAM devices, like DRAM device 200, can have significantly more memory cells 225 (for example, tens, hundreds, or thousands of memory cells) per row or per column.

In this example, each memory cell 225 can include a single transistor 221 and a single capacitor 229, which is commonly referred to as a 1T1C (one-transistor-one capacitor cell). One plate of capacitor 229, which can be termed the “node plate,” is connected to the drain terminal of transistor 221, whereas the other plate of the capacitor 229 is connected to ground 224 or other reference node. Each capacitor 229 within the array of 1T1C memory cells 225 typically serves to store one bit of data, and the respective transistor 221 serves as an access device to write to or read from storage capacitor 229.

The transistor gate terminals within each row of rows 254-1, 254-2, 254-3, and 254-4 are portions of respective WLs 230-1, 230-2, 230-3, and 230-4, and the transistor source terminals within each of columns 256-1, 256-2, 256-3, and 256-4 are electrically connected to respective BLs 235-1, 235-2, 235-3, and 235-4. A row decoder 232 can selectively drive the individual WLs 230-1, 230-2, 230-3, and 230-4, responsive to row address signals 231 input to row decoder 232. Driving a given WL at a high voltage causes the access transistors within the respective row to conduct, thereby connecting the storage capacitors within the row to the respective BLs, such that charge can be transferred between the BLs and the storage capacitors for read or write operations. Both read and write operations can be performed via SA circuitry 240, which can transfer bit values between memory cells 225 of the selected row of the rows 254-1, 254-2, 254-3, and 254-4 and input/output buffers 246 (for write/read operations) or external input/output data buses 248.

A column decoder 242 responsive to column address signals 241 can select which of the memory cells 225 within the selected row is read out or written to. Alternatively, for read operations, the storage capacitors 229 within the selected row can be read out simultaneously and latched, and the column decoder 242 can then select which latch bits to connect to the output data bus 248. Since read-out of the storage capacitors destroys the stored information, the read operation is accompanied by a rewrite of the capacitor charge. Further, in between read/write operations, the capacitor charge is repeatedly refreshed to prevent data loss.

DRAM device 200 can be implemented as an IC within a package that includes pins for receiving supply voltages (for example, to provide the source and gate voltages for the transistors 221) and signals (including data, address, and control signals). FIG. 2 depicts DRAM device 200 in simplified form to illustrate basic structural components, omitting many details of the memory cells 225 and associated WLs 230-1, 230-2, 230-3, and 230-4 and BLs 235-1, 235-2, 235-3, and 235-4 as well as the peripheral circuitry. For example, in addition to the row decoder 232, column decoder 242, Sense Amplifier (SA) circuitry 240, and buffers 246, DRAM device 200 can include further peripheral circuitry, such as a memory control circuit (e.g., the memory control circuit 115). The memory control circuit may control the memory operations based on control signals (provided, for example, by a host device, an external processor, etc.), additional input/output circuitry, or other features associated with a memory device. The peripheral circuitry can be located above the array of memory cells 225 in a CoA architecture using a wafer-to-wafer interconnect architecture. Alternatively, the peripheral circuitry can be located under the array of memory cells 225 in a CuA architecture. Alternatively, the peripheral circuitry can be located in a region of the IC of the memory device adjacent to an array region having the array of memory cells 225.

In two-dimensional (2D) DRAM arrays, the rows 254-1, 254-2, 254-3, and 254-4 and columns 256-1, 256-2, 256-3, and 256-4 of memory cells 225 can be arranged along a single horizontal plane (i.e., a plane parallel to the layers) of the semiconductor substrate, for example, in a rectangular lattice with WLs 230-1, 230-2, 230-3, and 230-4 and BLs 235-1, 235-2, 235-3, and 235-4. In 3D DRAM arrays, the memory cells 225 can be arranged in a 3D lattice with a page of memory cells and associated WLs and BLs at a level above another page of memory cells and their associated WLs and BLs.

Memory devices having identical or similar features to example DRAM device 200 can be implemented in a variety of electronic host devices. Electronic host devices, such as mobile electronic devices (for example, smart phones, tablets, and other similar communication-related devices), electronic devices for use in automotive applications (for example, automotive sensors, control units, driver-assistance systems, passenger safety systems, comfort systems, or other similar systems), and internet-connected appliances or devices (for example, internet-of-things (IoT) devices, or other network-related devices), have varying storage needs depending on, among other things, the type of electronic device, use environment, performance expectations, or other criteria.

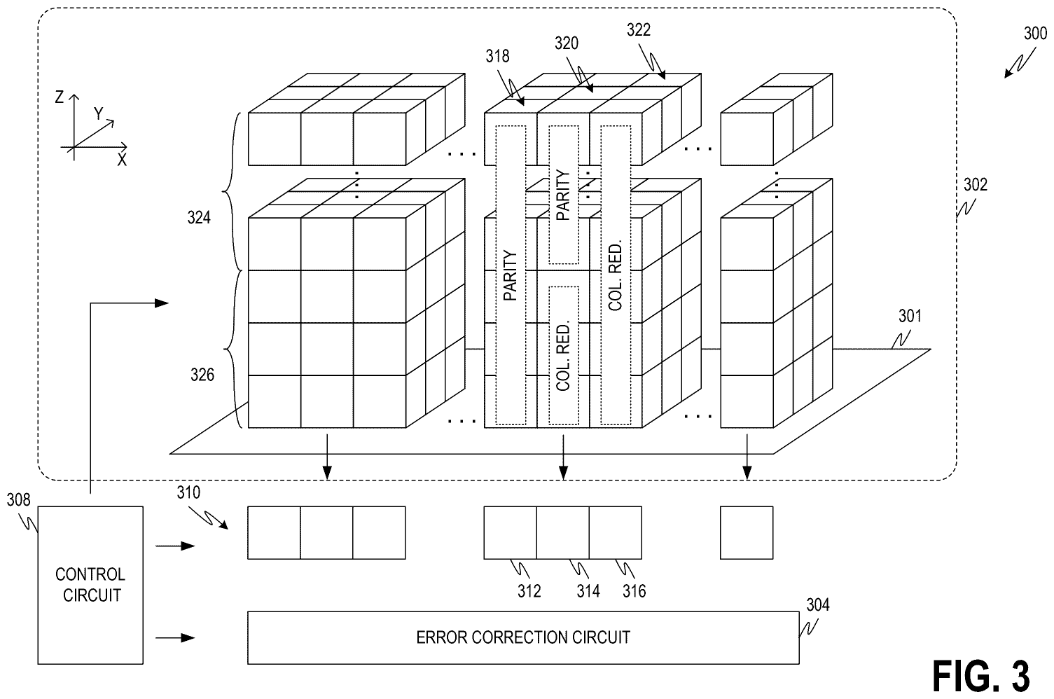

FIG. 3 is a diagram showing one example of a memory device 300. The memory device 300 includes a control circuit 308 and a memory array 302 including a hybrid column 320. The control circuit 308 may be configured in a manner similar to that of the memory control circuit 115. The memory array 302 is fabricated on, or coupled to, a die. A portion of the die may be in the shape of a plane 301. The memory array 302 may comprise memory cells arranged in a three-dimensional manner into rows, columns, and pages. In this example, memory cells are represented by three-dimensional boxes. Rows of memory cells are arranged in the direction indicated by the Y-axis, columns of memory cells are arranged in the direction indicated by the X-axis, and pages of memory cells are arranged in the direction indicated by the Z-axis. In this example, the direction indicated by the Z-axis extends away from the plane 301 of the die while the directions indicated by the X-axis and Y-axis are parallel to the plane 301 of the die.

In the example of FIG. 3, the memory array 302 may be read from and/or written to by page. Each page may have respective sensing circuits 310. The sensing circuits may comprise various amplifiers, analog-to-digital converters, multiplexers, and/or the like. The sensing circuits 310 for a column may be configured to read from and/or write to a set of memory cells in the corresponding column. In some examples, individual sensing circuits 310 may be arranged to read from and/or write to a number of memory cells from the corresponding column that are in a selected row and page. In some examples, the sensing circuits 310 are configured to read from and/or write to an error correction circuit 304.

The total number of columns, rows, and pages in the memory array 302 may vary depending on the implementation. In some examples, there may be 8 rows, 16 rows, 20 rows, 32 rows, and/or the like. Also, in some examples there may be 8 columns, 11 columns, 16 columns, 20 columns, 32 columns, and/or the like. Also, for example, there may be 8 pages, 20 pages, 16 pages, 32 pages, and/or the like.

The error correction circuit 304 may be arranged to generate one or more parity bits for data that is written to the memory array 302. Any suitable algorithm may be used to generate the one or more parity bits. The error circuit 304 may also be arranged to use parity bits to detect and, in some examples, correct for errors in read data.

The error correction circuit 304 may comprise a data input for receiving data and a parity bit input for receiving one or more parity bits. The error correction circuit 304 may be configured to apply parity bits received at parity bit input to data received at the data input pins to detect and/or correct errors in the data. In some examples, the error correction circuit 304 may have a data output for providing corrected data. Also, in some examples, the data input and data output are implemented using the same pin or pins.

In some examples, the error correction circuit 304 includes one or more parity bit outputs. When data to be written to the memory array 302 is provided at the data input of the error correction circuit 304, the error correction circuit may generate one or more parity bits and cause those parity bits to appear at one or more parity bit output pins. In some examples, the parity input and output of the error correction circuit 304 may be implemented using the same pins. Also, for example, the data input of the error correction circuit 304 for generating parity bits may be different than the data input of the error correction circuit 304 for checking parity.

In the example of FIG. 3, a first column 318 of the array 302 stores parity bits. In some examples, the first column 318 stores parity bits for data stored in cells in other columns. Accordingly, a first sensing circuit 312 associated with the first column 318 may sense memory cells of the first column 318 associated with the particular page and be configured to provide a column output of the first column 318 to the parity bit input of the error correction circuit 304. The error correction circuit 304 may consider the bits of the column output of the first column 318 to be parity bits (e.g., ECC bits) associated with the data sensed from the other columns.

A third column 322 of the array 302, in this example, is a column redundancy column. For example, a third sensing circuit 316 associated with the third column 322 may be configured to direct a column output of the third column 322 in place of the column output of another column of the memory array 302. For example, the third sensing circuit 316 may be configured to selectively direct the column output of the third column 322 to the sensing circuit 310 of another column and/or to a data input of the error correction circuit 304.

In the example of FIG. 3, a second column 320 is a hybrid column. For a first portion 324 of the pages of the memory array 302, the second column 320 stores parity data. For a second portion 326 of the pages of the memory array 302, the second column 320 provides memory cells that may be used to implement column redundancy. In this example arrangement, the first portion 324 of pages of the memory array 302 may use the first and second columns 318, 320 to store parity bits. The error correction circuit 304 may be arranged to detect and correct relatively larger numbers of bit errors in the data stored at the first portion 324 of the pages of the memory array 302. Also, the second portion 326 of the pages of the memory array 302 may have use of additional column redundancy cells. This may raise the tolerance for failures or fabrication defects in the memory array with respect to the second portion 326 of the pages. Although a single hybrid column (i.e., the second column 320) is shown in FIG. 3, it will be appreciated that some memory arrays may include multiple hybrid columns. The example of FIG. 3 shows two portions 324, 326 of the pages of the memory array 302, however, it will be appreciated that some memory arrays may include more than two portions of pages, with each portion having a different number of associated parity bits. For example, an arrangement having two hybrid columns may have three portions of pages having different numbers of associated parity bits.

A second sensing circuit 314 can be associated with the hybrid column (i.e., the second column 320) and may be configured to selectively direct a column output sensed from the second column 320 the error correction circuit 304 as either parity bits at a parity input or as data bits at a data input. For example, when a page of the first portion 324 is read from, the second sensing circuit 314 may be configured to provide data read from the second column 320 to a parity data input of the error correction circuit 304. When a page of the first portion 324 is written to, the second sensing circuit 314 may be configured to provide data from the parity bit output of the error correction circuit 304 to the memory cells of the second column 320.

When a page of the second portion 326 of the pages is written to, the second sensing circuit 314 may be configured to direct data intended for another column of the memory array 302 to the second column 320, for example, as configured. Similarly, when a page of the second portion 326 of the pages is read from, the second sensing circuit 314 may be configured to direct a column output from the third column 322 another sensing circuit 310 and/or to the error correction circuit 304 as a data input.

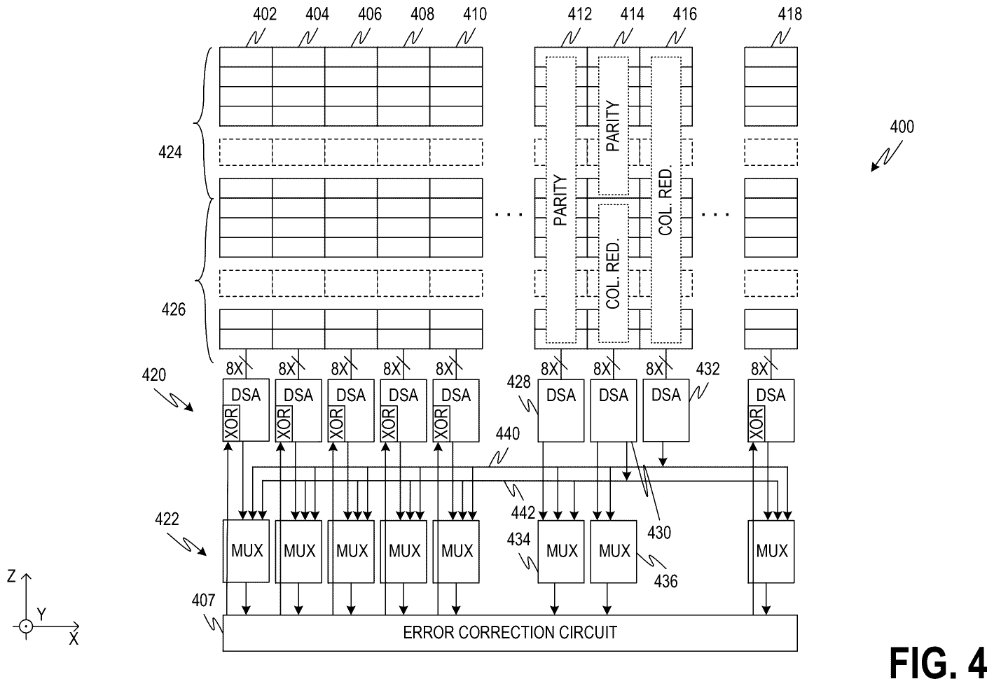

FIG. 4 is a diagram showing one example of a memory device 400 including a hybrid column 414. In the example of FIG. 4, memory cells are arranged in three dimensions according to columns and rows positioned parallel to the X-Y plane and pages extending in the direction of the Z-axis. In this example, rows of memory cells may extend into and/or out of the page in the direction of the Y-axis. Also, in the example of FIG. 4, ten columns 402, 404, 406, 408, 410, 412, 414, 416, 418 are shown. It will be appreciated, however, that memory arrays as described herein may include more or fewer columns than are shown. Also, in this example, twelve pages are shown. It will be appreciated that memory arrays as described herein may include more or fewer than twelve pages. In the example of FIG. 4, each row includes eight memory cells, so a column of memory cells in a particular page includes eight bits. It will be appreciated, however, that memory arrays as described herein may include more or fewer than eight rows.

FIG. 4 shows an example of sensing circuitry for the respective columns including sense amplifiers 420 and multiplexers (MUXs) 422. An error correction circuit 407 is also provided. In the example of FIG. 4, columns 402, 404, 406, 408, 410, 418 are data columns including memory cells that store payload data. For each data column 402, 404, 406, 408, a respective sensing amplifier 420 may receive a column output sensed from the memory cells of the column and provide the column output to respective MUXs 422. The MUXs associated with data columns may receive, in this example, three inputs. A first input may be received from the sense amplifier 420 associated with the data column. A second input may be received from a first column redundancy bus 440. A third input may be received from a second column redundancy bus 442. The MUXs may be configured, for example, by a control circuit, to provide a selected one of the three inputs to the error correction circuit 407.

In the example of FIG. 4, the memory device 400 includes a column redundancy column 416. Sensing circuitry for the column redundancy column 416 may include a sensing amplifier 432. The sensing amplifier 432 may be configured to provide a column output read from the column redundancy column 416 to the first column redundancy bus 440. In this way, if one of the data columns 402, 404, 406, 408, 410, 418 is found to be defective, for example, during or after fabrication, then the particular MUX 422 associated with the defective data column 402, 404, 406, 408, 410, 418 may be configured to pass the content of the first column redundancy bus 440 to the data input of the error correction circuit 407. In this way, the column redundancy column 416 may act as a substitute for the one defective data column 402, 404, 406, 408, 410, 418.

The memory device 400 includes a parity column 412 that stores parity data. For example, the column 402 may store eight bits of parity data for each page. In examples in which there are eight data columns, this may come to a single parity bit for each data column. Sensing circuitry for the parity column 412 may comprise a sensing amplifier 428 and a MUX 434. The MUX 434 may have three inputs. A first input may receive the column output of the parity column 412 provided by the sensing amplifier 428. In some examples, a second input may receive the first column redundancy bus 440 and a third input may be coupled to the second column redundancy bus 442. The MUX 434 may be configured to direct either the column output of the parity column 412 (from the sense amplifier 428), the first column redundancy bus 440, or the second column redundancy bus 442 to the error correction circuit 407. In this way, if the parity column 412 is determined to be defective, then a column redundancy column, such as column 416, may be used to store parity data.

The memory device 400 includes a hybrid column 414 that stores parity data with respect to a first portion 424 of the pages and provides column redundancy for the portion 426 of the pages. The sensing circuitry for the hybrid column 414 comprises a sense amplifier 430 and a MUX 436. The sense amplifier 430 is electrically coupled to provide column output from the hybrid column 414 to the second column redundancy bus 442 and to the MUX 436. The MUX 436 may be configured to provide to the error correction circuit 407 the output of the sense amplifier 430, the first column redundancy bus 440, or the second column redundancy bus. In some examples, the sensing amplifier 430 and/or MUX 436 are electrically coupled to selectively provide the column output of the hybrid column 414 to a parity bit input of the error correction circuit 407 or to a data input of the error correction circuit 407. In some examples, the sensing circuitry for the hybrid column 414 (e.g., the sense amplifier 430 and MUX 436) may selectively provide the column output of the hybrid column 414 to the parity bit input of the error correction circuit 407 when a page from the first portion 424 of the memory device 400 pages is read, and provide the column output of the hybrid column 414 to the second column redundancy bus 442 when a page from the second portion 426 of the memory device 400 pages is read.

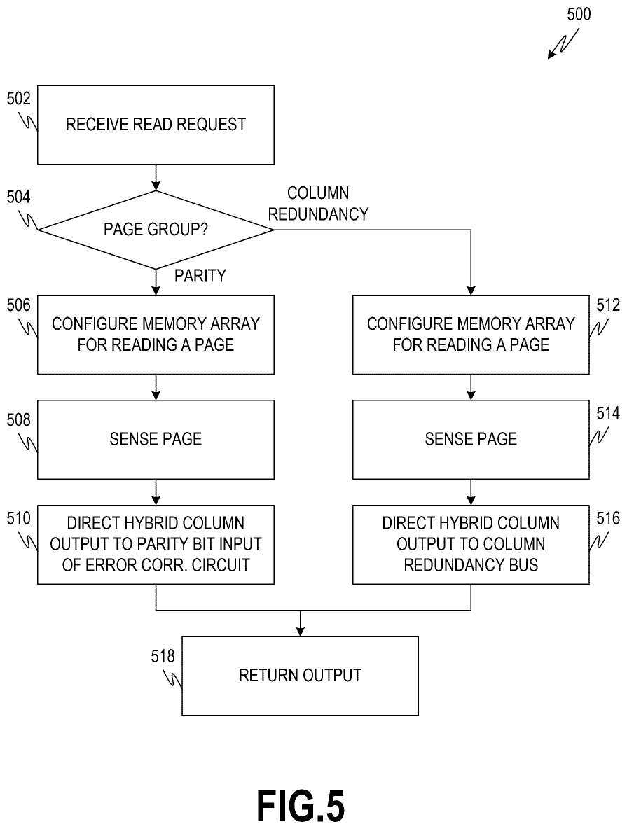

FIG. 5 is a flowchart showing one example of a process flow 500 that may be implemented in a memory device using at least one hybrid column to respond to a read request. The process flow 500 may be executed using any of the suitable memory devices described herein including, for example, memory devices 110 and 300. At operation 502, the memory device may receive a read request. The read request may specify an address at a memory array of the memory device (e.g., a logical address or a physical address). The address may correlate to a page or portion of a page that is to be read. At operation 504, the memory device may determine whether the page to be read is part of a page group using a hybrid column for parity data or part of a page group using the hybrid column for column redundancy.

If the page to be read is part of the page group using the hybrid column for parity data, then the memory device may, at operation 506, configure the memory array for reading the page. At operation 508, the memory device may sense the page, resulting in a set of column outputs. At operation 510, the memory device may direct a column output of the hybrid column to a parity bit input of an error correction circuit. At operation 518, the memory device may return an output. The output may be, for example, a verified and/or corrected data output from the error correction circuit.

If, at operation 504, the memory device determines that the page to be read is part of the page group using the hybrid column for column redundancy data, then the memory device may, at operation 512, configure the memory array for reading the page. At operation 514, the memory device may sense the page, resulting in a set of column outputs. At operation 516, the memory device may direct the column output of the hybrid column to a column redundancy bus. As described herein, the memory device may comprise a set of MUXs associated with columns that are not column redundancy columns. The set of MUXs may be selectively configured to provide the output at the column redundancy bus to the error correction circuit in place of a column output of one of the other columns. At operation 518, the memory device may return an output. The output may be, for example, a verified and/or corrected data output from the error correction circuit.

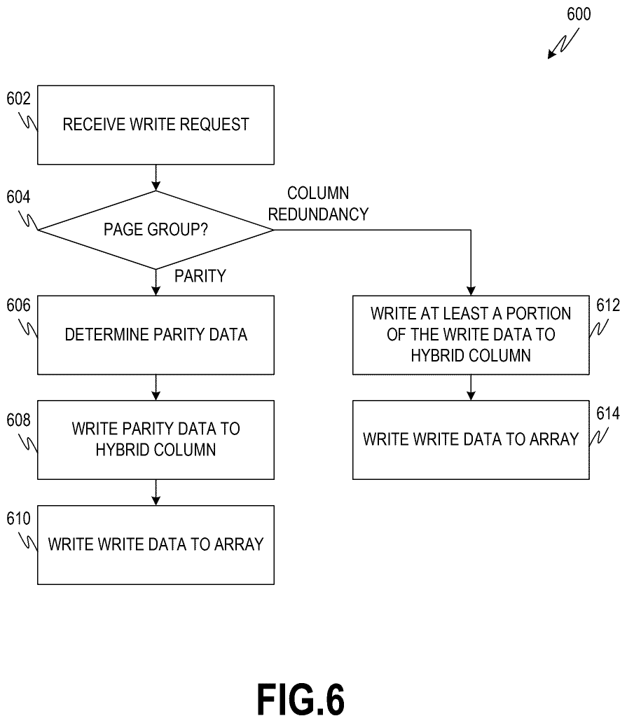

FIG. 6 is a flowchart showing one example of a process flow 600 that may be implemented in a memory device using at least one hybrid column to respond to a write request. At operation 602, the memory device may receive a write request. The write request may include, for example, write data to be written to a memory array of the memory device. In some examples, the write request includes an address indicating where the write data should be written at the memory array. In some examples, the memory device determines where the write data should be written at the memory array. At operation 604, the memory device determines whether the page where the write data is to be written (sometimes referred to herein as a destination page) is part of a page group using a hybrid column for parity data or part of a page group using the hybrid column for column redundancy.

If the destination page is part of the page group using the hybrid column for parity data, then the memory device may, at operation 606, determine parity data for the write data. At operation 608, the memory device may write at least a portion of the parity data to the hybrid column. At operation 610, the memory device may write the write data to a different portion of the memory array using cells outside of the hybrid column. In some examples, operations 608 and 610 may be performed simultaneously.

If, at operation 604, the memory device determines that the destination page is part of the page group using the hybrid column for column redundancy data, then the memory device may, at operation 612, write at least a portion of the write data to memory cells that comprise the hybrid column. At operation 614, the memory device may write the remainder of the write data to a different portion of the memory array using cells outside of the hybrid column. In some examples, the operations 612 and 614 may be performed simultaneously.

FIG. 7 illustrates a block diagram of an example machine 700 upon which or with which any one or more of the techniques (e.g., methodologies) discussed herein may perform. In alternative embodiments, the machine 700 may operate as a standalone device or may be connected (e.g., networked) to other machines. In a networked deployment, the machine 700 may operate in the capacity of a server machine, a client machine, or both in server-client network environments. In an example, the machine 700 may act as a peer machine in a peer-to-peer (P2P) (or other distributed) network environment. The machine 700 may be a personal computer (PC), a tablet PC, a set-top box (STB), a personal digital assistant (PDA), a mobile telephone, a web appliance, an IoT device, automotive system, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic, components, devices, packages, or mechanisms. Circuitry is a collection (e.g., set) of circuits implemented in tangible entities that include hardware (e.g., simple circuits, gates, logic, etc.). Circuitry membership may be flexible over time and underlying hardware variability. Circuitries include members that may, alone or in combination, perform specific tasks when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable participating hardware (e.g., the execution units or a loading mechanism) to create members of the circuitry in hardware via the variable connections to carry out portions of the specific tasks when in operation. Accordingly, the computer readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time.

The machine (e.g., computer system) 700 (e.g., the host device 105, the memory device 110, 300, 400, etc.) may include a hardware processor 702 (e.g., a CPU, a GPU, a hardware processor core, or any combination thereof, such as the memory control circuit 115, 308, etc.), a main memory 704, and a static memory 706, some or all of which may communicate with each other via an interlink (e.g., bus) 708. The machine 700 may further include a display unit 710, an alphanumeric input device 712 (e.g., a keyboard), and a user interface (UI) navigation device 714 (e.g., a mouse). In an example, the display unit 710, input device 712, and UI navigation device 714 may be a touch screen display. The machine 700 may additionally include a storage device, a signal generation device 718 (e.g., a speaker), a network interface device 720, and one or more sensors 717, such as a global positioning system (GPS) sensor, compass, accelerometer, or other sensor. The machine 700 may include an output controller 728, such as a serial (e.g., USB, parallel, or other wired or wireless (e.g., infrared (IR), near field communication (NFC), etc.) connection to communicate or control one or more peripheral devices (e.g., a printer, card reader, etc.).

The storage device 722 may include a non-transitory machine-readable medium on which is stored one or more sets of data structures or instructions 724 (e.g., software) embodying or utilized by any one or more of the techniques or functions described herein. The instructions 724 may also reside, completely or at least partially, within the main memory 704, within static memory 706, or within the hardware processor 702 during execution thereof by the machine 700. In an example, one or any combination of the hardware processor 702, the main memory 704, the static memory 706, or the storage device 722 may constitute the machine-readable medium.

While the machine-readable medium is illustrated as a single medium, the term “machine-readable medium” may include a single medium or multiple media (e.g., a centralized or distributed database, or associated caches and servers) configured to store the one or more instructions 724.

The term “machine-readable medium” may include any medium that is capable of storing, encoding, or carrying instructions for execution by the machine 700 and that cause the machine 700 to perform any one or more of the techniques of the present disclosure, or that is capable of storing, encoding or carrying data structures used by or associated with such instructions. Non-limiting machine-readable medium examples may include solid-state memories, and optical and magnetic media. In an example, a massed machine-readable medium comprises a machine-readable medium with a plurality of particles having invariant (e.g., rest) mass. Accordingly, massed machine-readable media are not transitory propagating signals. Specific examples of massed machine-readable media may include: non-volatile memory, such as semiconductor memory devices (e.g., EPROM, EEPROM) and flash memory devices; magnetic disks, such as internal hard disks and removable disks; magneto-optical disks; and CD-ROM and DVD-ROM disks.

The instructions 724 (e.g., software, programs, an operating system (OS), etc.) or other data stored on a storage device 721, can be accessed by the memory 704 for use by the processor 702. The memory 704 (e.g., DRAM) is typically fast, but volatile, and thus a different type of storage than the storage device 721 (e.g., an SSD), which is suitable for long-term storage, including while in an “off” condition. The instructions 724 or data in use by a user or the machine 700 are typically loaded in the memory 704 for use by the processor 702. When the memory 704 is full, virtual space from the storage device 721 can be allocated to supplement the memory 704; however, because the storage device 721 device is typically slower than the memory 704, and write speeds are typically at least twice as slow as read speeds, use of virtual memory can greatly reduce user experience due to storage device latency (in contrast to the memory 704, e.g., DRAM). Further, use of the storage device 721 for virtual memory can greatly reduce the usable lifespan of the storage device 721.

In contrast to virtual memory, virtual memory compression (e.g., the Linux® kernel feature “ZRAM”) uses part of the memory as compressed block storage to avoid paging to the storage device 721. Paging takes place in the compressed block until it is necessary to write such data to the storage device 721. Virtual memory compression increases the usable size of memory 704, while reducing wear on the storage device 721.

Storage devices for mobile electronic devices, or mobile storage, traditionally include MMC solid-state storage devices (e.g., micro Secure Digital (microSD™) cards, etc.). MMC devices include a number of parallel interfaces (e.g., an 8-bit parallel interface) with a host device and are often removable and separate components from the host device. In contrast, eMMC™ devices are attached to a circuit board and considered a component of the host device, with read speeds that rival SATA based SSD devices. However, demand for mobile device performance continues to increase, such as to fully enable virtual or augmented-reality devices, utilize increasing network speeds, etc. In response to this demand, storage devices have shifted from parallel to serial communication interfaces. UFS devices, including controllers and firmware, communicate with a host device using a low-voltage differential signaling (LVDS) serial interface with dedicated read/write paths, further advancing greater read/write speeds.

The instructions 724 may further be transmitted or received over a communications network 726 using a transmission medium via the network interface device 720 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 720 may include one or more physical jacks (e.g., Ethernet, coaxial, or phone jacks) or one or more antennas to connect to the communications network 726. In an example, the network interface device 720 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 700, and includes digital or analog communications signals or other intangible medium to facilitate communication of such software.

The above detailed description includes references to the accompanying drawings, which form a part of the detailed description. The drawings show, by way of illustration, specific embodiments in which the disclosure can be practiced. These embodiments are also referred to herein as “examples,” Such examples can include elements in addition to those shown or described. However, the present inventors also contemplate examples in which only those elements shown or described are provided. Moreover, the present inventors also contemplate examples using any combination or permutation of those elements shown or described (or one or more examples thereof), either with respect to a particular example (or one or more examples thereof), or with respect to other examples (or one or more examples thereof) shown or described herein.

In various examples, the components, controllers, processors, units, engines, or tables described herein can include, among other things, physical circuitry or firmware stored on a physical device. As used herein, “processor” means any type of computational circuit such as, but not limited to, a microprocessor, a microcontroller, a graphics processor, a digital signal processor (DSP), or any other type of processor or processing circuit, including a group of processors or multi-core devices.

The term “horizontal” as used in this document is defined as a plane parallel to the conventional plane or surface of a substrate, such as that underlying a wafer or die, regardless of the actual orientation of the substrate at any point in time. The term “vertical” refers to a direction perpendicular to the horizontal as defined above. Prepositions, such as “on,” “over,” and “under” are defined with respect to the conventional plane or surface being on the top or exposed surface of the substrate, regardless of the orientation of the substrate; and while “on” is intended to suggest a direct contact of one structure relative to another structure which it lies “on” (in the absence of an express indication to the contrary); the terms “over” and “under” are expressly intended to identify a relative placement of structures (or layers, features, etc.), which expressly includes—but is not limited to—direct contact between the identified structures unless specifically identified as such. Similarly, the terms “over” and “under” are not limited to horizontal orientations, as a structure may be “over” a referenced structure if it is, at some point in time, an outermost portion of the construction under discussion, even if such structure extends vertically relative to the referenced structure, rather than in a horizontal orientation.

Various embodiments according to the present disclosure and described herein include memory utilizing a vertical structure of memory cells (e.g., NAND strings of memory cells). As used herein, directional adjectives will be taken relative a surface of a substrate upon which the memory cells are formed (i.e., a vertical structure will be taken as extending away from the substrate surface, a bottom end of the vertical structure will be taken as the end nearest the substrate surface and a top end of the vertical structure will be taken as the end farthest from the substrate surface).

As used herein, directional adjectives, such as horizontal, vertical, normal, parallel, perpendicular, etc., can refer to relative orientations, and are not intended to imply strict adherence to specific geometric properties, unless otherwise noted. For example, as used herein, a vertical structure need not be strictly perpendicular to a surface of a substrate, but may instead be generally perpendicular to the surface of the substrate, and may form an acute angle with the surface of the substrate (e.g., between 60 and 120 degrees, etc.).

In some embodiments described herein, different doping configurations may be applied to a source-side select gate (SGS), a control gate, and a drain-side select gate (SGD), each of which, in this example, may be formed of or at least include polysilicon, with the result such that these tiers (e.g., polysilicon, etc.) may have different etch rates when exposed to an etching solution. For example, in a process of forming a monolithic pillar in a 3D semiconductor device, the SGS and the control gate may form recesses, while the SGD may remain less recessed or even not recessed. These doping configurations may thus enable selective etching into the distinct tiers (e.g., SGS, control gate, and SGD) in the 3D semiconductor device by using an etching solution (e.g., tetramethylammonium hydroxide (TMCH)).

Operating a memory cell, as used herein, includes reading from, writing to, or erasing the memory cell. The operation of placing a memory cell in an intended state is referred to herein as “programming,” and can include both writing to or erasing from the memory cell (e.g., the memory cell may be programmed to an erased state).

According to one or more embodiments of the present disclosure, a memory controller (e.g., a processor, controller, firmware, etc.) located internal or external to a memory device, is capable of determining (e.g., selecting, setting, adjusting, computing, changing, clearing, communicating, adapting, deriving, defining, utilizing, modifying, applying, etc.) a quantity of wear cycles, or a wear state (e.g., recording wear cycles, counting operations of the memory device as they occur, tracking the operations of the memory device it initiates, evaluating the memory device characteristics corresponding to a wear state, etc.)

According to one or more embodiments of the present disclosure, a memory access device may be configured to provide wear cycle information to the memory device with each memory operation. The memory device control circuitry (e.g., control logic) may be programmed to compensate for memory device performance changes corresponding to the wear cycle information. The memory device may receive the wear cycle information and determine one or more operating parameters (e.g., a value, characteristic) in response to the wear cycle information.

It will be understood that when an element is referred to as being “on,” “connected to,” or “coupled with” another element, it can be directly on, connected, or coupled with the other element or intervening elements may be present. In contrast, when an element is referred to as being “directly on,” “directly connected to,” or “directly coupled with” another element, there are no intervening elements or layers present. If two elements are shown in the drawings with a line connecting them, the two elements can either be coupled, or directly coupled, unless otherwise indicated.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, the code can be tangibly stored on one or more volatile or non-volatile tangible computer-readable media, such as during execution or at other times. Examples of these tangible computer-readable media can include, but are not limited to, hard disks, removable magnetic disks, removable optical disks (e.g., compact discs and digital video disks), magnetic cassettes, memory cards or sticks, RAMs, ROMs, SSDs, UFS device, eMMC device, and the like.

### Examples

Example 1 is a memory device comprising: a memory array comprising memory cells arranged into pages, rows, and columns, wherein each of the memory cells is respectively associated with a particular page, row, and column of the memory array; and a first column of the memory array is configured to store parity data for a first portion of the pages and to store column redundancy data for a second portion of the pages.
In Example 2, the subject matter of Example 1 optionally includes a column redundancy bus; an error correction circuit including a parity bit input; and a first sensing circuit electrically coupled to sense signals from memory cells of the first column, the first sensing circuit being electrically coupled to provide a first column output to the parity bit input when the memory array is configured for reading a page selected from the first portion of the pages, and the first sensing circuit being electrically coupled to provide the first column output to the column redundancy bus when the memory array is configured for reading a page selected from the second portion of the pages.
In Example 3, the subject matter of Example 2 optionally includes a second sensing circuit electrically coupled to sense memory cells of a second column of the memory array, the second sensing circuit being electrically coupled to provide a second column output to a data input of the error correction circuit.
In Example 4, the subject matter of Example 3 optionally includes a third sensing circuit electrically coupled to sense memory cells of a third column of the memory array, the third sensing circuit being electrically coupled to provide a third column output to the parity bit input of the error correction circuit.
In Example 5, the subject matter of any one or more of Examples 3-4 optionally include a fourth sensing circuit electrically coupled to sense memory cells of a fourth column of the memory array, the fourth sensing circuit being electrically coupled to provide a fourth column output to a second column redundancy bus.
In Example 6, the subject matter of any one or more of Examples 3-5 optionally include a multiplexer circuit electrically coupled to selectively direct the first column output to the parity bit input of the error correction circuit or to the column redundancy bus.
In Example 7, the subject matter of any one or more of Examples 3-6 optionally include a third sensing circuit electrically coupled to sense memory cells of a third column of the memory array, the third sensing circuit being electrically coupled to provide a third column output to the parity bit input of the error correction circuit; a fourth sensing circuit electrically coupled to sense memory cells of a fourth column of the memory array, the fourth sensing circuit being electrically coupled to provide a fourth column output to a second column redundancy bus; and a multiplexer circuit electrically coupled to selectively direct the first column output to the parity bit input of the error correction circuit or to the column redundancy bus.
In Example 8, the subject matter of any one or more of Examples 3-7 optionally include a second column multiplexer circuit electrically coupled to receive the second column output and the first column output, the second column multiplexer circuit configured to generate an output based on the second column output when the memory array is configured for reading a page selected from the first portion of the pages, and to generate an output based on the first column output when the memory array is configured for reading a page selected from the second portion of the pages.
Example 9 is a method of operating a memory device comprising a memory array, the memory array comprising a number of memory cells arranged into a number of pages, a number of rows, and a number of columns, with each respective memory cell of the number of memory cells being part of a particular column of the number of columns, a particular row of the number of rows, and a particular page of the number of pages, the method comprising: configuring the memory array for reading a first page of the number of pages; while the memory array is configured for reading the first page, sensing a first column of the number of columns to receive a first column parity output; providing the first column parity output to a parity bit input of an error correction circuit of the memory device; configuring the memory array for reading a second page of the number of pages; while the memory array is configured for reading the second page, sensing the first column of the number of columns to receive a first column redundancy output; and providing the first column redundancy output to a first column redundancy bus of the memory device.
In Example 10, the subject matter of Example 9 optionally includes while the memory array is configured for reading the first page, sensing a second column of the number of columns to receive a second column output for the first page; providing the second column output for the first page to a data input of the error correction circuit; while the memory array is configured for reading the second page, sensing the second column to receive a second column output for the second page; and providing the second column output for the second page to the data input of the error correction circuit.
In Example 11, the subject matter of any one or more of Examples 9-10 optionally include wherein the first column is configured to store parity data for a first portion of the number of pages and column redundancy data for a second portion of the number of pages, the first portion of the number of pages comprising the first page and the second portion of the number of pages comprising the second page.
In Example 12, the subject matter of any one or more of Examples 9-11 optionally include sensing a third column of the number of columns to receive a third column output; and providing the third column output to the parity bit input of the error correction circuit.
In Example 13, the subject matter of any one or more of Examples 9-12 optionally include while the memory array is configured for reading the first page, sensing a third column of the number of columns to receive a third column output for the first page; providing the third column output for the first page to a second column redundancy bus of the memory device; while the memory array is configured for reading the second page, sensing the third column to receive a third column output for the second page; and providing the third column output for the second page to the second column redundancy bus of the memory device.
In Example 14, the subject matter of any one or more of Examples 9-13 optionally include the providing of the first column parity output to the parity bit input of the error correction circuit comprising configuring a multiplexer to direct an output of the first column to the parity bit input of the error correction circuit.
In Example 15, the subject matter of any one or more of Examples 9-14 optionally include modifying a second column multiplexer associated with a second column of the number of columns to direct the first column parity output from the first column redundancy bus to a data input of the error correction circuit associated with the second column.
In Example 16, the subject matter of any one or more of Examples 9-15 optionally include receiving first write data for writing to the first page of the number of pages; determining first parity data for the first write data; writing the first parity data to the first column; writing the first write data to at least one other column of the number of columns; receiving second write data for writing to a second page of the number of pages; and writing at least a portion of the second write data to a portion to the first column.
Example 17 is a memory device comprising: an error correction circuit; a memory array comprising a number of memory cells arranged into a number of pages, a number of rows, and a number of columns, each respective memory cell of the number of memory cells being part of a column of the number of columns, a row of the number of rows, and a page of the number of pages; means for configuring the memory array for reading a selected page of the number of pages; means for sensing memory cells of a first column of the number of columns; and means for providing a first column output to a parity bit input of the error correction circuit when the memory array is configured for reading a page selected from a first portion of the number of pages, and for providing the first column output to a column redundancy bus when the memory array is configured for reading a page selected from a second portion of the number of pages.
In Example 18, the subject matter of Example 17 optionally includes means for sensing memory cells of a second column of the number of columns; and means for providing a second column output to a data input of the error correction circuit.
In Example 19, the subject matter of any one or more of Examples 17-18 optionally include means for sensing memory cells of a third column of the number of columns; and means for providing a third column output to the parity bit input of the error correction circuit.
In Example 20, the subject matter of any one or more of Examples 17-19 optionally include means for sensing memory cells of a fourth column of the number of columns; and means for providing a fourth column output to a second column redundancy bus.

The above description is intended to be illustrative, and not restrictive. For example, the above-described examples (or one or more examples thereof) may be used in combination with each other. Other embodiments can be used, such as by one of ordinary skills in the art upon reviewing the above description. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations.

1. A memory device comprising:
a memory array comprising memory cells arranged into pages, rows, and columns, wherein each of the memory cells is respectively associated with a particular page, row, and column of the memory array; and
a first column of the memory array is configured to store parity data for a first portion of the pages and to store column redundancy data for a second portion of the pages.

2. The memory device of claim 1, further comprising:
a column redundancy bus;
an error correction circuit including a parity bit input; and
a first sensing circuit electrically coupled to sense signals from memory cells of the first column, the first sensing circuit being electrically coupled to provide a first column output to the parity bit input when the memory array is configured for reading a page selected from the first portion of the pages, and the first sensing circuit being electrically coupled to provide the first column output to the column redundancy bus when the memory array is configured for reading a page selected from the second portion of the pages.

3. The memory device of claim 2, further comprising a second sensing circuit electrically coupled to sense memory cells of a second column of the memory array, the second sensing circuit being electrically coupled to provide a second column output to a data input of the error correction circuit.

4. The memory device of claim 3, further comprising a third sensing circuit electrically coupled to sense memory cells of a third column of the memory array, the third sensing circuit being electrically coupled to provide a third column output to the parity bit input of the error correction circuit.

5. The memory device of claim 3, further comprising a fourth sensing circuit electrically coupled to sense memory cells of a fourth column of the memory array, the fourth sensing circuit being electrically coupled to provide a fourth column output to a second column redundancy bus.

6. The memory device of claim 3, further comprising a multiplexer circuit electrically coupled to selectively direct the first column output to the parity bit input of the error correction circuit or to the column redundancy bus.

7. The memory device of claim 3, further comprising:
a third sensing circuit electrically coupled to sense memory cells of a third column of the memory array, the third sensing circuit being electrically coupled to provide a third column output to the parity bit input of the error correction circuit;
a fourth sensing circuit electrically coupled to sense memory cells of a fourth column of the memory array, the fourth sensing circuit being electrically coupled to provide a fourth column output to a second column redundancy bus; and
a multiplexer circuit electrically coupled to selectively direct the first column output to the parity bit input of the error correction circuit or to the column redundancy bus.

8. The memory device of claim 3, further comprising a second column multiplexer circuit electrically coupled to receive the second column output and the first column output, the second column multiplexer circuit configured to generate an output based on the second column output when the memory array is configured for reading a page selected from the first portion of the pages, and to generate an output based on the first column output when the memory array is configured for reading a page selected from the second portion of the pages.

9. A method of operating a memory device comprising a memory array, the memory array comprising a number of memory cells arranged into a number of pages, a number of rows, and a number of columns, with each respective memory cell of the number of memory cells being part of a particular column of the number of columns, a particular row of the number of rows, and a particular page of the number of pages, the method comprising:
configuring the memory array for reading a first page of the number of pages;
while the memory array is configured for reading the first page, sensing a first column of the number of columns to receive a first column parity output;
providing the first column parity output to a parity bit input of an error correction circuit of the memory device;
configuring the memory array for reading a second page of the number of pages;
while the memory array is configured for reading the second page, sensing the first column of the number of columns to receive a first column redundancy output; and
providing the first column redundancy output to a first column redundancy bus of the memory device.

10. The method of claim 9, further comprising:
while the memory array is configured for reading the first page, sensing a second column of the number of columns to receive a second column output for the first page;
providing the second column output for the first page to a data input of the error correction circuit;
while the memory array is configured for reading the second page, sensing the second column to receive a second column output for the second page; and
providing the second column output for the second page to the data input of the error correction circuit.

11. The method of claim 9, wherein the first column is configured to store parity data for a first portion of the number of pages and column redundancy data for a second portion of the number of pages, the first portion of the number of pages comprising the first page and the second portion of the number of pages comprising the second page.

12. The method of claim 9 further comprising:
sensing a third column of the number of columns to receive a third column output; and
providing the third column output to the parity bit input of the error correction circuit.

13. The method of claim 9 further comprising:
while the memory array is configured for reading the first page, sensing a third column of the number of columns to receive a third column output for the first page;
providing the third column output for the first page to a second column redundancy bus of the memory device;
while the memory array is configured for reading the second page, sensing the third column to receive a third column output for the second page; and
providing the third column output for the second page to the second column redundancy bus of the memory device.

14. The method of claim 9, the providing of the first column parity output to the parity bit input of the error correction circuit comprising configuring a multiplexer to direct an output of the first column to the parity bit input of the error correction circuit.

15. The method of claim 9, further comprising modifying a second column multiplexer associated with a second column of the number of columns to direct the first column parity output from the first column redundancy bus to a data input of the error correction circuit associated with the second column.

16. The method of claim 9, further comprising:
receiving first write data for writing to the first page of the number of pages;
determining first parity data for the first write data;
writing the first parity data to the first column;
writing the first write data to at least one other column of the number of columns;
receiving second write data for writing to a second page of the number of pages; and
writing at least a portion of the second write data to a portion to the first column.

17. A memory device comprising:
an error correction circuit;
a memory array comprising a number of memory cells arranged into a number of pages, a number of rows, and a number of columns, each respective memory cell of the number of memory cells being part of a column of the number of columns, a row of the number of rows, and a page of the number of pages;
means for configuring the memory array for reading a selected page of the number of pages;
means for sensing memory cells of a first column of the number of columns; and
means for providing a first column output to a parity bit input of the error correction circuit when the memory array is configured for reading a page selected from a first portion of the number of pages, and for providing the first column output to a column redundancy bus when the memory array is configured for reading a page selected from a second portion of the number of pages.

18. The memory device of claim 17, further comprising:
means for sensing memory cells of a second column of the number of columns; and
means for providing a second column output to a data input of the error correction circuit.

19. The memory device of claim 17, further comprising:
means for sensing memory cells of a third column of the number of columns; and
means for providing a third column output to the parity bit input of the error correction circuit.

20. The memory device of claim 17, further comprising:
means for sensing memory cells of a fourth column of the number of columns; and
means for providing a fourth column output to a second column redundancy bus.
